(19) United States
(12) Patent Application Publication
(10) Pub. No.: US 2006/0162199 A1
(43) Pub. Date: Jul. 27, 2006

(54) Handheld item having a handle with a convertible display element

(75) Inventors: William Y. Kang, New York, NY (US); Chi Ming Tse, Kwai Chung (HK)

Correspondence Address: Thomas J. Brindisi, Esq., Suite B, 20 28th Place, Venice, CA, 90291, US

(73) Assignee: Pollen Design, Inc.

(21) Appl. No.: 11/040,934

(22) Filed: Jan. 21, 2005

(51) Int. Cl. A47J 43/28

(52) U.S. Cl. 40/446; 294/8

(57) ABSTRACT

A handheld item, for example a utensil such as a spatula, including a handle with a convertible display element that readily converts between one of at least two visual display items. The display conversion may preferably be accomplished through rotary movement of the display items between visible and hidden positions.

### FIELD OF THE INVENTION

The present invention relates to handheld implements, and more particularly, to a handheld utensil such as a spatula having a handle with a visual display element that readily converts between one of at least two items via rotary movement of the items between visible and hidden positions.

### BACKGROUND OF THE INVENTION

Frequently handheld items such as cooking utensils are used repeatedly and/or for prolonged periods of time. Hitherto the appearance of such handheld items is generally fixed except to the extent of artifacts of usage or wear, for example, food spatter or burns that may accumulate on a cooking spatula from time to time. The generally fixed appearance of such handheld items may over time become less appealing to the user. Moreover, in some contexts, such as where the handheld item may be used in more than one specific setting or purpose, it may be desired that the handheld item take on one of at least two specific appearances that in some way complements or corresponds to the setting or purpose in which it is being used.

### SUMMARY OF THE INVENTION

In accordance with the present invention, an exemplary embodiment of a handheld item includes a handle with a convertible display element. The handheld item may be any suitable item, for example, a utensil such as a spatula. The convertible display element may readily convert between one of at least two visual display items via rotary movement of the items between visible and hidden positions.

### BRIEF DESCRIPTION OF THE DRAWINGS

FIG. 1 is a top perspective view of an embodiment of the present invention.

FIG. 2 is a bottom perspective view corresponding to that of FIG. 1.

FIG. 3 is an exploded partial view of the embodiment of FIGS. 1 and 2 showing the handle.

FIG. 4 is an exploded partial view similar to FIG. 3 but showing only the end of the handle and the constituents of its convertible display.

FIGS. 5-7 are a sequence of views of the end of the handle of the embodiment of the invention depicted in FIGS. 1-4, showing a first item on display in the convertible display element in FIG. 5, a second item on display in the convertible display element in FIG. 7, and a transitory appearance of part of both items that momentarily occurs during rotary switching of the display element from one item to the other.

FIG. 8 is a view of the two display items shown in FIGS. 5-7, showing their opposing mounting on the rotary convertible display element.

FIG. 9 is a view of a part of the mechanism depicted in FIGS. 3 and 4 cut into two halves.

FIG. 10 is a partial cutaway perspective view of the part depicted in FIG. 8.

### DETAILED DESCRIPTION OF A PREFERRED EMBODIMENT

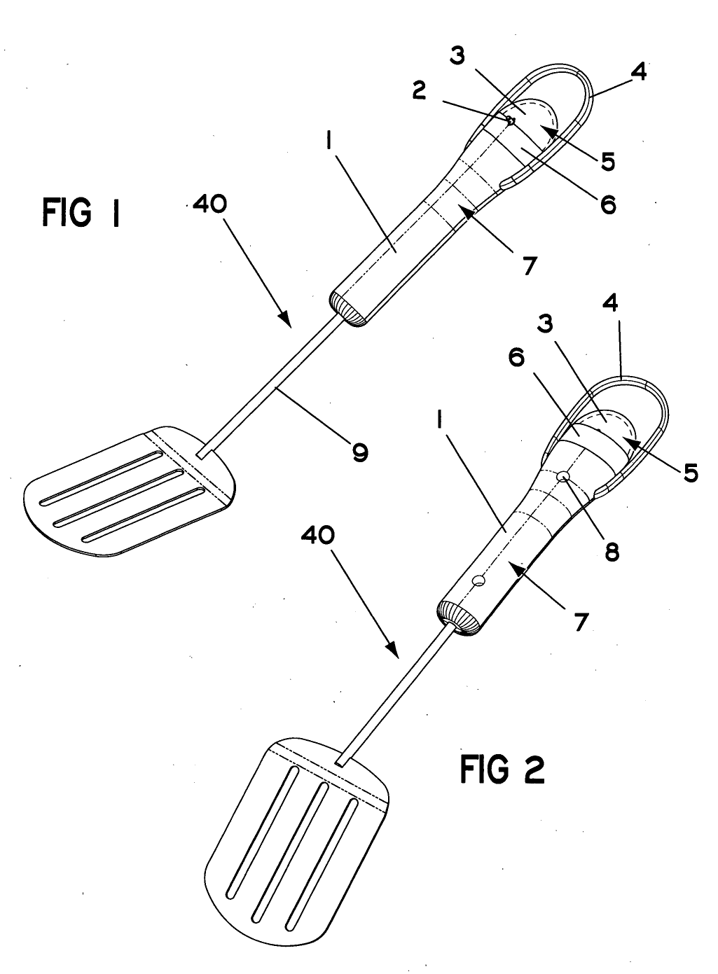

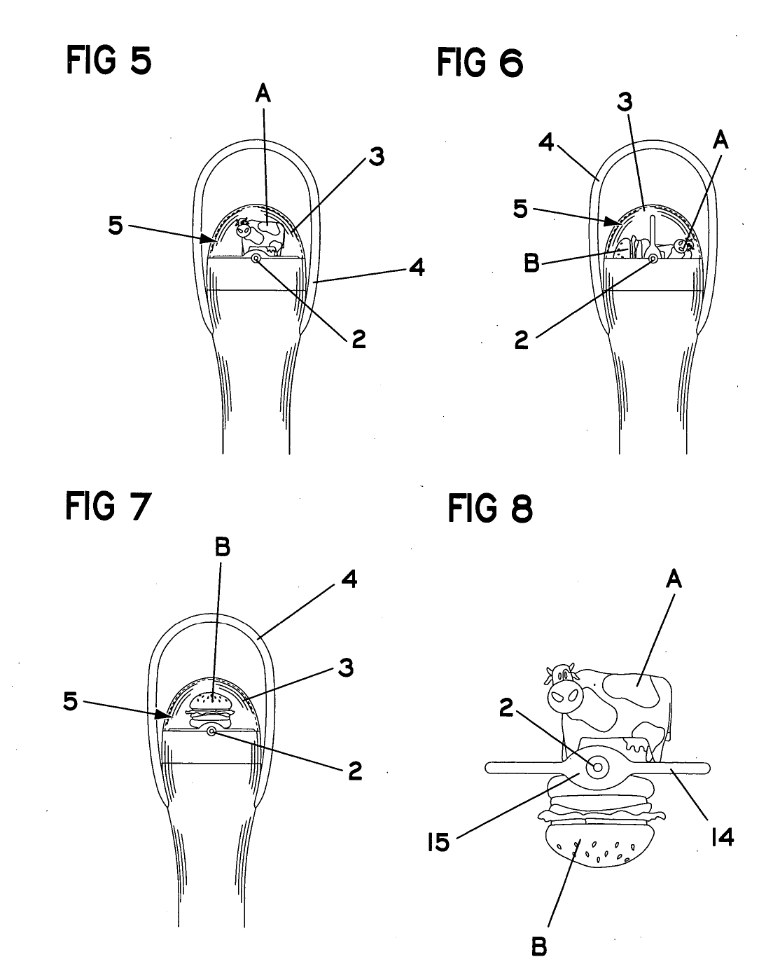

Details of a preferred embodiment of the present invention are described in the context of the example of a cooking spatula. Referring to FIGS. 1-3, a spatula 40 in accordance with the present invention has a handle 7 with a convertible display element 5. The spatula 40 includes a preferably metallic stem 9 and top and bottom molded plastic handle halves 1, which are secured to each other and the stem 9 by bolts (not shown) at bolt holes 8 in the bottom handle half and corresponding nuts (not shown) embedded in the interior of the top handle half. The handle 7 ends in a hanging loop 4 and a convertible display element 5 the salient external features of which comprise translucent bubble 3, shoulder band 6, and manual display button 2. The manual display button 2 protrudes outwardly, for example approximately an eighth inch to a quarter inch, and when manually depressed inwardly, causes a display item within the translucent bubble 3 (see FIGS. 5-8) to rotate out of view and be replaced by another display item.

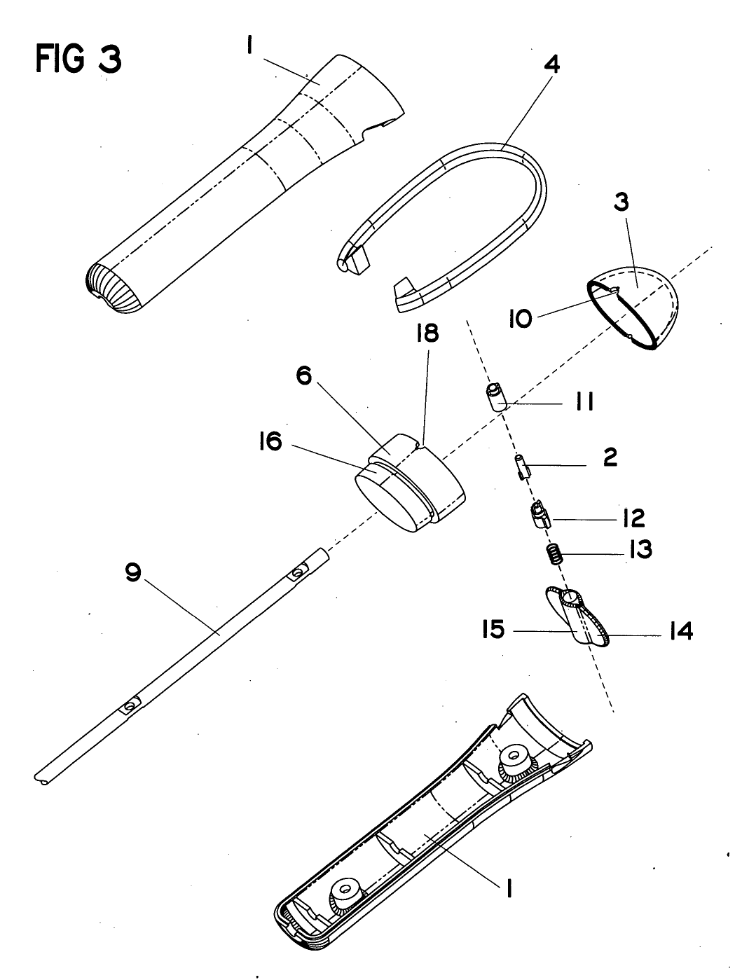

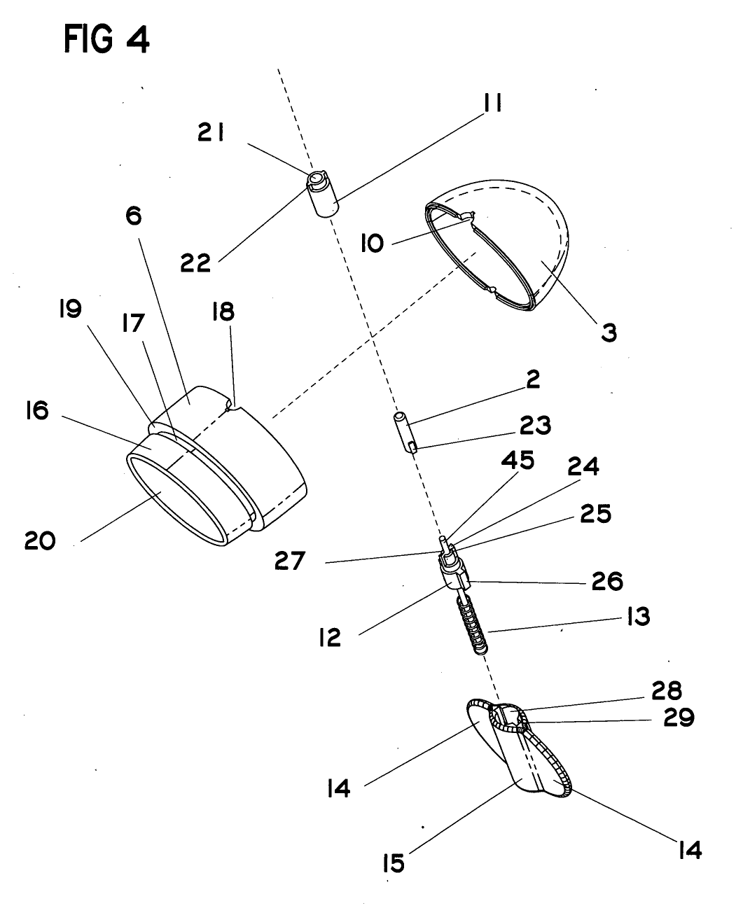

Referring now particularly to FIGS. 3 and 4, the convertible display element 5 is hollow and primarily includes an upper half and a lower half joined together such as by a suitable glue. The upper half comprises the translucent bubble 3, which is preferably molded plastic, while the lower half comprises the shoulder band 6 and a lower internal band 16 that terminates in an opening 20. The lower half is preferably molded of opaque plastic in a single piece, with the lower internal band 16 being circumferentially delineated from the shoulder band 6 by a recessed circumferential groove 17. The lower internal band 16 fits snugly within a corresponding circumferential recession in the end of handle halves 1, and similarly a circumferential rim in the end of handle halves 1 fits snugly within recessed circumferential groove 17, with the bottom 19 of shoulder band 6 snugly abutting the endmost circumferential edge of handle halves 1.

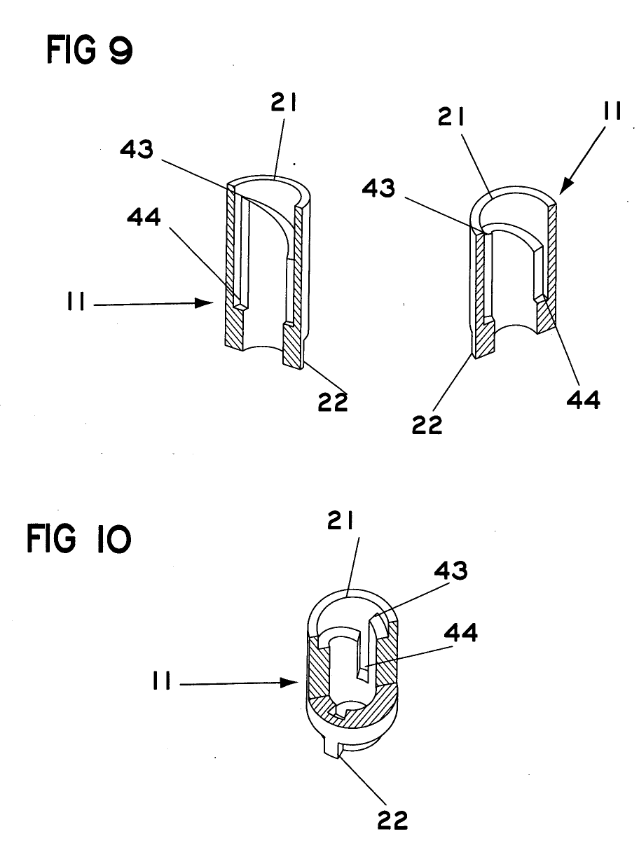

The mechanism of action of the rotation between display items can best be understood from FIGS. 4, 9, and 10. (For simplicity, the actual display items are omitted from the depiction of FIG. 4, but are shown as “A” and “B” mounted on the rotary plate 14 in FIG. 8). The mechanism consists primarily of axle 45, which is preferably metallic, and rotary plate 14, spinner 12, manual button 2, and sleeve 11, each of which is preferably a single, integral molded plastic piece. In use, spring 13 sheathes the bottom of axle 45, and both extend through rotary plate 14 with the bottom end of axle 45 fixedly abutted against the interior of convertible display element 5 (preferably against a small notch defined in the translucent bubble 3 and shoulder band 6 directly opposite from half apertures 10 and 18, and preferably with an annular abutment (not shown) fixed near the bottom end of the axle 45 preventing it from sliding out of convertible display element 5). Spinner 12 sheathes a middle portion of axle 45 with the top of axle 45 protruding through the top of spinner passage 25 and partly protruding (to an extent that varies according to the extent to which the user manually depresses manual button 2) into the hollow bottom (not shown) of manual button 2. The bottom of manual button 2, between minor lugs 23, is preferably provided with two opposing rounded notches that seat against corresponding notches 27 at the top of spinner 12 between shifting lugs 24, with the notches of the spinner 12 and those of the manual button 2 arranged such that the shifting lugs 24 and minor lugs 23 are always approximately 30 to 90 degrees out of phase with respect to each other but can rotate somewhat easily back or forth within some part of that range. Manual button 2 also passes through sleeve passage 21 with minor lugs 23 sliding within the arcuate channels 44 defined by the internally protruding arcuate guides 43 in sleeve 11, preferably such that approximately one-third to one-half of the length of the manual button 2 extends through the top end of sleeve 11 and the tops of minor lugs 23 abut the ends of the arcuate channels 43 toward the top of the sleeve 11 when manual button 2 is not being manually depressed by a user. Fixed lugs 22 and the narrowed top of sleeve 11 are securely affixed to the convertible display element 5 at corresponding notched, half apertures 10 and 18 therein, such as by glue, so that sleeve 11 is fixed in place with respect to convertible display element 5 and the spring 13 is approximately one-third compressed when manual button 2 is not being manually depressed by a user. The axle 45 preferably has a length approximately equal to the outer diameter of convertible display element 5 as measured through notches 10 and 18. Wing lugs 26 lie within the plate passage 28 defined within the central area 15 of rotary plate 14, which internally has opposing slots 29 that mate with the wing lugs 26 so as to prevent rotation of the rotary plate 14 with respect to the wing lugs 26 when they are placed within the opposing slots 29 of the rotary plate 14.

Rotation of rotary plate 14 is thus effected by rotation of wing lugs 26, which is produced by depression of manual button 2. In general, depression of manual button 2 causes wing lugs 26 to rotate through action similar to that described in U.S. Pat. No. 3,019,767 to Ambros (which is incorporated herein by reference for its disclosure of a spring-biased, manual-activated rotation mechanism), however, the two possible spring-biased resting positions (defined by arcuate channels 44) of the mechanism of the present embodiment are axially equal, i.e., the manual button 2, axle 45, sleeve 11, spinner 12, and spring 13 each extend out to the same axial position in either resting position. When a user is not depressing manual button 2 against the bias of spring 13, rotary plate 14 is always parallel to the seam between translucent bubble 3 and shoulder band 6, because the spring 13 biases shifting lugs 24 against the curved tops of arcuate guides 43 and into the narrowed portions of arcuate channels 44, which are only slightly wider than the diameter of shifting lugs 24 such that shifting lugs 24 are radially locked in place within arcuate channels 44. The inner diameter of the passages in sleeve 11 is slightly greater than the outer diameter of manual button 2, and the inner diameter of the hollow portion of manual button 2 and of spinner 12 are slightly greater than the outer diameter of axle 45 so that these parts can axially slide with respect to each other, thus permitting a user to depress manual button 2, forcing spinner 12 further into spring 13, further compressing spring 13. When the user depresses manual button 2 against the bias of spring 13 far enough to force the shifting lugs 24 above the pointed tips of arcuate guides 43, the shifting lugs 24 rapidly urge radially somewhat beyond the pointed tips of arcuate guides 43 such that each shifting lug 24 is more aligned with the arcuate channel 44 opposite from which it just departed. Removing pressure from manual button 2 causes shifting lugs 24 to slide back (due to the bias of spring 13) down the arcuate leading edges of arcuate guides 43 and into the arcuate channels 44 opposite from prior to the activation of manual button 2. Consequently, depressing the manual button 2 sufficiently and then removing pressure from it causes rotary plate 14 to turn 180 degrees within convertible display element 5, and repeating the process causes the same action just described, perpetually in the same radial direction.

Use of the embodiment just described is shown in the sequence of FIGS. 5-7, wherein a first item A is displayed within the convertible display element 5 in FIG. 5, a second item B is displayed within the convertible display element in FIG. 7, and a transitory appearance of part of both items A and B momentarily occurs during rotation of the rotary plate 14 in response to depression of manual button 2. As evident from the description above, the parts may be configured such that rotation of the rotary plate 14 stops relatively rapidly once becomes parallel to the seam between translucent bubble 3 and shoulder band 6. Rounding of the notches on manual button 2 and/or the corresponding notches 27 on spinner 12 may serve to provide some “play” so as to reduce some of the shock and resulting wear of an otherwise overly rapid rotational deceleration.

A preferred embodiment of a handheld item having a handle with a convertible display element has thus been disclosed. It will be apparent, however, that various changes may be made in the form, construction, and arrangement of the system without departing from the spirit and scope of the invention, the form hereinbefore described being merely a preferred or exemplary embodiment thereof. For example, the convertible display element of the present invention can be utilized in other items such as in various utensils (kitchen, barbeque, etc.), in signage for example to indicate stop and go, in an on and off switch, in a doorbell, in a cat door-flap to indicate whether the cat is in or out, in a charging station to indicate whether it is charging or not, in an open/close indicator, in a hot/cold indicator, in a bathroom occupied/vacant indicator, in a children's remote control (e.g., with different TV characters), in a shoe heel insert that changes with each step, in pens, pencils, and other writing instruments, in keychains, in a toothbrush (with illustrations for dirty teeth versus clean teeth), in an open/closed sign that attaches to a store window such as with a suction cup, and in jewelry, necklaces, pendants and rings. Moreover, in other embodiments of the present invention, more than just two display items can be achieved, such as by utilizing a rotary plate that has three or more sections (and modifying the mechanism of rotation correspondingly), so that instead of rotating 180 degrees each time, the rotary plate rotates 120 degrees (three sections), 90 degrees (four sections), etc. at a time, with the manual button thus needing to be pressed three or more times to rotate the plate 360 degrees. Finally, the rotation mechanism of the present invention can be alternately be powered by other means such as electrically with a solenoid activated automatically (e.g., controlled by a microprocessor running a program and/or in response to one or more external stimuli such as temperature, pressure, etc.) or by a user pressing a button. Therefore, the invention is not to be restricted or limited except in accordance with the following claims.

What is claimed is:

1. A handheld item having a convertible display element comprising:
a) at least two visual display items mounted on a convertible display;
b) a housing connected to said convertible display and including an opaque portion; and,
c) a manual button connected to said convertible display;
wherein activation of said manual button causes said convertible display to physically move one of said at least two visual display items from a visible position to a position that is visually obscured by said opaque portion of said housing.

2. The handheld item of claim 1, further comprising a handle, wherein said convertible display element is located on said handle.

3. The handheld item of claim 2, wherein said handle has an end, and said convertible display element is located at said end of said handle.

4. The handheld item of claim 2, wherein said handheld item is a cooking utensil.

5. The handheld item of claim 2, wherein said housing further includes a transparent portion.

6. The handheld item of claim 1, wherein said convertible display is a rotary plate, and said at least two visual display items consist of exactly two visual display items.

7. The handheld item of claim 1, further comprising a handle, wherein said convertible display element is located on said handle.

8. The handheld item of claim 7, wherein said handle has an end, and said convertible display element is located at said end of said handle.

9. The handheld item of claim 7, wherein said handheld item is a cooking utensil.

10. The handheld item of claim 7, wherein said housing further includes a transparent portion.

11. A handheld item having a convertible display element comprising:
a) at least two visual display items mounted on a convertible display;
b) a housing including an opaque portion;
c) a manual button connected to said convertible display; and,
d) a display converting means for physically moving the position of said convertible display in response to manual depression of said manual button such that one of said at least two visual display items moves from a visible position to a position that is visually obscured by said opaque portion of said housing.

12. The handheld item of claim 1, further comprising a handle, wherein said convertible display element is located on said handle.

13. The handheld item of claim 12, wherein said handle has an end, and said convertible display element is located at said end of said handle.

14. The handheld item of claim 12, wherein said handheld item is a cooking utensil.

15. The handheld item of claim 12, wherein said housing further includes a transparent portion.

16. The handheld item of claim 1, wherein said convertible display is a rotary plate, and said at least two visual display items consist of exactly two visual display items.

17. The handheld item of claim 1, further comprising a handle, wherein said convertible display element is located on said handle.

18. The handheld item of claim 17, wherein said handle has an end, and said convertible display element is located at said end of said handle.

19. The handheld item of claim 17, wherein said handheld item is a cooking utensil.

20. The handheld item of claim 17, wherein said housing further includes a transparent portion.
